(19) United States
(12) Patent Application Publication
(10) Pub. No.: US 2004/0128534 A1
(43) Pub. Date: Jul. 1, 2004

(54) Method and product for identifying a website visitor session by visitor e-mail address

(76) Inventor: Nicholas John Walker, Austin, TX (US)

Correspondence Address: Michael A. Ervin, 8202 Talbot Cove, Austin, TX, 78746, US

(21) Appl. No.: 10/735,949

(22) Filed: Dec. 15, 2003

Related U.S. Application Data
(60) Provisional application No. 60/433,977, filed on Dec. 18, 2002.

(51) Int. Cl. G06F 11/30

(52) U.S. Cl. 713/200

(57) ABSTRACT

A method and product for tracking, correlating, and analyzing a visitor's e-mail and website access and behavior. Tracking enabled e-mails and web pages with embedded communication software are used to capture and store a visitor's e-mail address in a cookie. A unique identifier is added to the cookie, and the cookie is imbedded in the HTML rendering component of the visitor's e-mail application and web browser, so that information from the visitor's access to e-mail and access to a website and behavior there can be stored and used between the two applications and analyzed by proprietary software.

### CROSS-REFERENCE TO RELATED APPLICATIONS

This application claims the benefit of PPA Serial No. 60/433,977, filed Dec. 18, 2002 by the present inventor.

### FIELD OF THE INVENTION

This innovation relates to tracking an Internet visitor's activities on any given website, and, more particularly, to a system and method for tracking, correlating, and analyzing a visitor's e-mail access and website access and behavior.

### BACKGROUND OF THE INVENTION

Owners of commercial websites want to send promotional e-mails to visitors and automatically and precisely identify those visitors who open the e-mails as well as those who visit the websites. These owners also want to automatically and precisely identify visitors to their websites, and record and analyze their behavior there. Moreover, these owners would like to correlate the two sets of information, associated with e-mail use and website behavior, to better analyze the use and effectiveness of their promotional e-mails and websites and to target and coordinate their sales and marketing strategies to the previous behavior of specific visitors and customers.

Prior Techniques

Log-file analysis: One way website owners and their employees have tried to record and analyze information about visitor behavior on their websites is by log-file analysis. From their web servers, employees have collected the log files containing website visitor requests and have analyzed them through custom-written or special third-party software on personal computers, using the visitors' Internet protocol (IP) addresses as identifiers.

Alternately, they have used custom-written or special third-party software to store cookies on the visitors' web browsers so that the cookies will be recorded in the log files, and have then used the cookies as unique identifiers for analysis.

However, the limitations of log-file analysis make it unnecessarily complicated and restricted. Using personal computer software to analyze log files is a manual process, which is slow and requires operator skill. The required software is time-consuming to create or often is very expensive to buy. Because log files can be very large (a typical analysis may process over a gigabyte of data), analysis of them is slow and error prone, especially because many websites employ multiple servers whose log files must all be collected and analyzed to extract the desired data. Because log-file analysis is slow, it cannot be done in real time but must be done in stages. If the log-file analysis is accomplished by using IP addresses, those addresses are not unique over time because the visitor's IP address changes with each new Internet session and thus log-file analysis often has a high associated error.

If analysis is accomplished by using cookies placed on web browsers, it is again slow and error prone, especially because, as mentioned above, many websites employ multiple servers whose log files must all be analyzed for the required data. Because server log files do not capture information about visitor e-mail interaction and are not typically configured to store e-mail addresses, even those stored in a cookie, from a web browser session, it is very difficult to correlate information from both sources.

Internet Based or Packet-sniffing analysis: Accordingly, website employees have attempted to gain better information about visitors by employing custom-written or special third-party software on multiple servers to do packet-stream analysis on visitor requests. When the visitor accesses a site, one set of this software, loaded on a web server for the site, stores a cookie on the HTML rendering component of the visitor's web browser, as an identifier with a unique number, and sends data about the visitor's access to different pages on the site to a proprietary database on a second server for analysis. Alternately, the server records the visitor's IP (Internet protocol) address as an identifier. Multiple other software programs may run on the same server for functions such as order processing, e-mails, and customer relationship management, and the site may employ multiple similar servers for these functions and for data collection. On the server with the proprietary database, an additional set of custom-written or special third-party software analyses the data it receives from the other server or servers for information about the visitor.

But packet-stream analysis also has many disadvantages. It is cumbersome because it must record and coordinate data from multiple software tools and pieces of hardware. The hardware and software required for the process are expensive (often costing $100,000 or more) and also require expensive implementation, training, and maintenance expenses. The process involves so many disparate pieces of software and hardware that it often cannot successfully capture and identify the required information.

The analytic software involved can only identify the web pages the visitor requested, and would need custom-written software to identify other functions the visitor carried out, such as order processing, filling out a form, and downloading a PDF file, which are accomplished by different sets of software. It does not capture and track e-mail statistics, such as whether a visitor opened a promotional e-mail, which again prevents easy correlation of information from both e-mails and web behavior.

Improved packet-stream analysis: As an improvement to the packet-stream analysis mentioned above, website employees have additionally used e-mail software tools to automatically identify visitors and analyze some of their behavior. They could send to potential visitors e-mails containing links to the websites. When the visitor uses such a link to access a site, custom-written or third party software on site's web server or servers creates a marketing campaign identifier for the visitor and records it in a cookie on the visitor's web browser. The software can use this identifier to record whether a potential visitor responded to the e-mail by clicking on the link and also whether the visitor placed an order or performed some other target action.

Even with this improvement, however, packet-stream analysis has serious limitations. It requires two separate software tools: an e-mail tool and an analysis tool. The custom-written software required is expensive and difficult to integrate. To identify a visitor by his or her e-mail address, this process requires that visitor to manually click on a link embedded in an e-mail message, and not everyone will do this.

U.S. Pat. No. 6,393,479 to Glommen describes an Internet-based analysis tool that follows the flow of traffic through a website. The state of the visitor's browser is maintained in a traffic analysis cookie that is passed between the website file server and the visitor browser when each page is viewed on that website. U.S. Pat. No. 6,11,240 to Pogue discloses a method and apparatus for obtaining client information relating to a web page in a web site utilizing a tracker code. U.S. Patent Publication 2003/0115074 A1 discloses a related system and method for tracking visitor activity. Visitors visiting web pages result in an impression being transmitted to a second website along with a unique identifier.

These patents and other similar ones are focused on tracking activity on a web page from a particular computer in a session but in many instances owners of commercial websites are most interested in being able to automatically and precisely identify targeted visitors and record and analyze their behavior. In addition they would like to correlate the two sets of information associated with e-mail use and website behavior so that they can routinely analyze the use and effectiveness of promotional e-mails as well as to target and coordinate their sales and marketing strategies to those targeted visitors with future e-mailings.

Therefore there is a need for a method for automatically and routinely identifying a web site visitor by e-mail address. Furthermore there is a need to do this using affordable and standardized software and to be able to do it in real time.

### BRIEF SUMMARY OF THE INVENTION

These and other needs are addressed by the present invention.

It is an aspect of the present invention to provide a method of tracking, correlating, and analyzing a visitor's e-mail and website access and behavior, that is automatic.

It is another aspect of the present invention to provide a method of tracking, correlating, and analyzing a visitor's e-mail and website access and behavior through standardized, inexpensive software.

It is another aspect of the present invention to provide a method of tracking, correlating, and analyzing a visitor's e-mail and website access, that is more accurate than prior methods.

It is another aspect of the present invention to provide a method of tracking, correlating, and analyzing a visitor's e-mail and website access, that is fast enough to be done in real time.

It is another aspect of the present invention to provide a method of tracking, correlating, and analyzing a visitor's e-mail and website access and behavior through a unique identifier that does not change with each Internet session.

It is another aspect of the present invention to provide a method of tracking, correlating, and analyzing a visitor's e-mail and website access and behavior through a simple system with a minimum number of software and hardware tools.

It is another aspect of the present invention to provide a method of tracking, correlating, and analyzing a visitor's e-mail and website access and behavior that does not require expensive hardware.

It is another aspect of the present invention to provide a method of tracking, correlating, and analyzing a visitor's e-mail and website access and behavior that is versatile enough to capture many forms of a visitor's website behavior.

These and other aspects, features, and advantages are achieved according to the method and apparatus of the instant invention. In accordance with the instant invention, service provider software tags e-mail or web page documents to create tracker-enabled documents with an embedded HTML or JavaScript tag that references a URL on the service provider server that can have the visitor's e-mail address embedded in the request string of the URL. In addition the tracker-enabled document has special service provider communication software embedded in it that enables the document to gather information about its usage and initiates a session that the service provider monitors. The tracker-enabled document can capture an visitor's e-mail address, store it in a cookie, add a unique identifier to the cookie, and embed the cookie in the HTML rendering component common to a website visitor's e-mail application and web browser, so that information can be stored and used between the two applications and analyzed by proprietary software. The tracker-enabled document can be either a web page or HTML enabled e-mail or other type of HTML enabled document.

In one application of the instant invention, software is used to automatically capture a visitor's e-mail address when an e-mail is opened in HTML format. It is important to note that it is not necessary for the visitor to click on a web site link in that e-mail. The software of the instant invention then automatically stores that e-mail address in a cookie, adds a unique identifier to the cookie, and embeds the cookie in the HTML rendering component of visitor's e-mail service. If the visitor's e-mail reader is a web browser, such as is used with the HotMail service for example, the cookie is embedded in that web browser. Because this HTML rendering component is very often common to the visitor's web browser and e-mail service, the information in the cookie can then be used to record information about that visitor's access to a website and his or her behavior there. Proprietary software can then analyze this information and produce reports about the visitor's behavior at the website.

In a second application, the visitor enters his e-mail address manually in an on-line form, and the software of the instant invention then stores that e-mail address in a cookie, adds a unique identifier to the cookie, and embeds the cookie in the HTML rendering component of the visitor's web browser.

In a third application, a visitor enters a username and password in a required on-line sign-in form, and the software of the instant invention employs the username to identify a previously stored e-mail address, captures that e-mail address, stores it in a cookie, adds a unique identifier to the cookie, and embeds the cookie in the HTML rendering component of the visitor's web browser. It should be noted that in this case the e-mail address of the visitor is available from a previous session in which the visitor provided an e-mail address when signing up with a username and password.

Thus an aspect of the instant invention is a method of tracking, correlating, and analyzing the e-mail and internet activities of an Internet visitor, which includes at least adding a tag to a document to create a tracker-enabled document; providing the tracker-enabled document to the visitor on the world wide web; and capturing an e-mail address from the visitor.

In this method the tracker-enabled document can be a web page that includes at least an embedded JavaScript or HTML tag that references a URL on a service provider server and enables the document to gather visitor information about the document's usage and initiates a session that the service provider monitors.

The invention also includes a software program product for use in a computer system that executes program steps to track, correlate, and analyze the e-mail and internet activities of an internet visitor. This product includes at least a program of computer readable instructions executable by the computer system to perform the method steps that include at least adding a tag to a document to create a tracker-enabled document, providing said tracker-enabled document to a visitor on the world wide web; and capturing an e-mail address from that visitor.

### BRIEF DESCRIPTION OF THE DRAWINGS

The following preferred embodiments of the present invention are described by way of example only, with reference to the accompanying drawings, in which:

FIG. 1 illustrates a typical system for tracking, correlating, and analyzing internet activities.

FIG. 2 is top-level flow chart of the process that the instant invention uses to embed the required cookie in a visitor's HTML rendering component.

FIG. 3 is a flow chart showing details for FIG. 2, Step 210.

FIG. 4 is a flow chart that shows details for FIG. 2, Step 220.

FIG. 5 illustrates details for FIG. 4, Step 4100.

### DETAILED DESCRIPTION

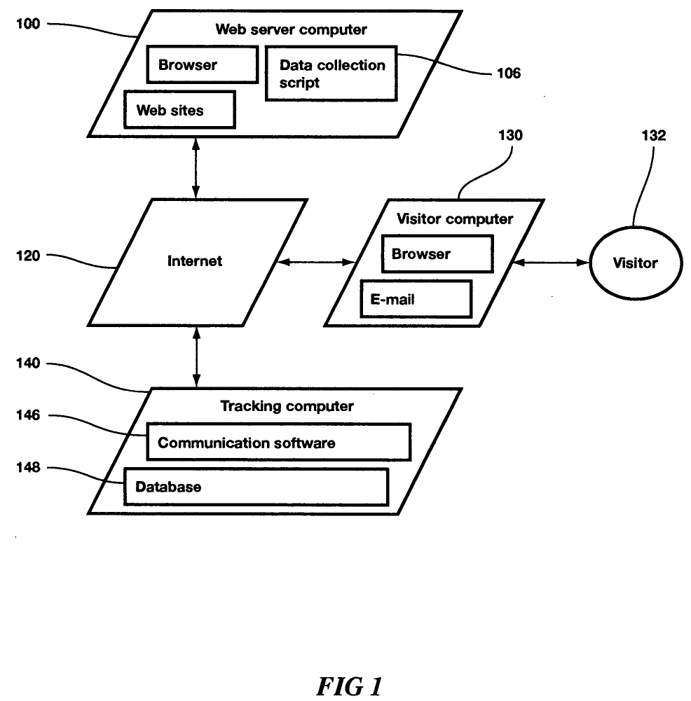

A typical network used in Internet based tracking systems is shown in FIG. 1. A web server computer 100, containing browser software and a commercial web site is connected to the Internet. A tracking computer 140, also connected to the internet, can contain multiple forms of software programs, but will have special communication software for tracking internet activities as well as databases for storing the results of that tracking. An Internet visitor 132, on a visitor computer 130, will have at least a browser and an e-mail program. Most of those e-mail programs today will operate in an ASCII text mode or an HTML rendering mode. Often the browser software and e-mail software share the same HTML rendering component.

A manner in which the instant invention's software can be implemented is for the owner of web server 100, to lease a service comprising the instant invention from a service provider on a tracking computer such as 140. For example, the owner of a commercial website leases the service from the owner of a service-provider website. The instant invention's communication software 146 would be located on computer 140 along with database 148. The communication software of the instant invention 146 is simplified and standardized for wide use, is not custom-written for each visitor, and does not have to be purchased from a third party. The owner of the commercial website on 100 could then download from the communication software special JavaScript or HTML software 106 to be stored on and used on 100.

The website owner of 100 can then send a promotional e-mail (either from 100 using an email client plug-in or from 140 using the service provider's e-mail tool), in either text or HTML format, to a visitor or multiple e-mails to many different visitors in mass mailings. If the e-mail is in text format, the communication software 146 converts it to HTML format before sending it. The e-mail sent contains a special HTML tag, for example an HTML IMG element with the e-mail address embedded in the request string of the SRC parameter. Communication software 146 uses that special HTML tag to automatically capture the e-mail address at communication device 130 when a visitor opens the e-mail or sets the focus of the e-mail service to it, to store that e-mail address in a cookie, to add a unique identifier to the cookie, and to store the cookie on the HTML rendering component of the visitor's e-mail service. If the visitor's e-mail reader is a web browser, such as is the case with the HotMail service for example; the cookie is stored in that web browser.

Alternately, the web site owner could access his account on computer 140 and download from communication software 146 plug-in software developed for an e-mail client for storage in computer 100. The web site owner can then employ computer 100 and the downloaded plug-in to create e-mails in text or HTML format and send them. The plug-in software converts text files to HTML files and adds the required HTML tags to all the e-mail files that are sent out with it.

In a second application, a visitor 132 on computer 130 uses the Internet to accesses computer 100 via HTTP or HTTPS protocol. Visitor then enters e-mail address manually in an on-line form, and the data-collection script 106 sends the email address to tracking computer 140 where 140 stores the e-mail address in a cookie, adds a unique identifier to the cookie, and then sends the cookie back to the visitor's web browser on visitor's computer 130. The browser on the visitor's computer 130 then embeds the cookie in the HTML rendering component of the visitor's web browser.

In a third application, a visitor 132 on computer 130 accesses computer 100 and then enters a visitor name and password in a required sign-in field. The data-collection script 106 then employs the username to identify a previously stored e-mail address for visitor 132, captures it and sends the email address to tracking computer 140 where 140 stores the e-mail address in a cookie, adds a unique identifier to the cookie, and then sends the cookie back to the visitor's web browser on visitor's computer 130. The browser on the visitor's computer 130 then embeds the cookie in the HTML rendering component of the visitor's web browser.

Subsequently, when a visitor 132 whose e-mail address has been captured, through any of the present invention's techniques mentioned above, visits computer 100, the data-collection script 106 stored there uses the identifying cookie to correlate the visitor's behavior on the site to the previously stored email address. Because the HTML rendering component is common to both e-mail services and web browsers, the data-collection script 106 can directly, easily, and efficiently compile data about the visitor 132 from his or her e-mail and website access and behavior.

When the web site owner wants a usage analysis, he accesses his account on computer 140 and uses its interface to select the desired type of analysis. For example, he might analyze whether visitors opened a promotional e-mail, how many pages they accessed on the site, what orders they placed, or other behavior of interest. Additionally, the web site owner can set up parameters on his or her account so that computer 140 will automatically send the web site owner e-mail alerts containing usage analysis.

The web site owner can then use the analyses in desired ways, for example to contact visitors with special offers and to redesign the website to address visitors' needs more effectively.

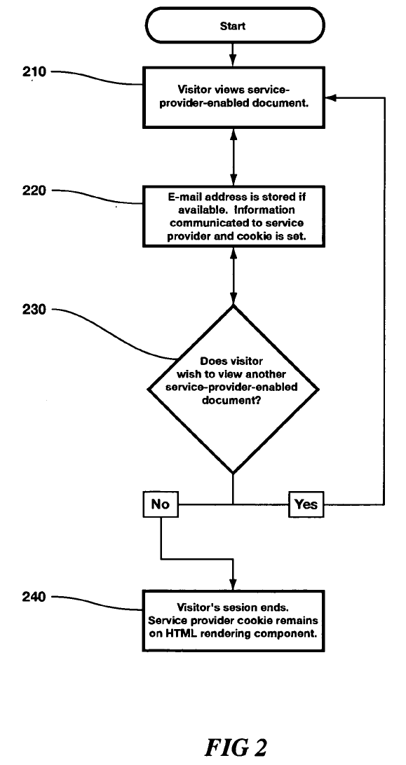

FIG. 2 illustrates the general process that the present innovation's software uses to embed the required cookie in a visitor's HTML rendering component when the visitor accesses a tracker-enabled document. A tracker-enabled or service provider-enabled document is one that has the data-collection script embedded in it, such as e-mail, an on-line form, or a required sign-in field.

Step 210: A visitor accesses a tracker-enabled document. The service provider's communication software enables the document to gather information about its usage and initiates a session that the service-provider monitors.

Step 220: Information collected in Step 210 by the embedded service-provider communication software is sent to the tracker computer. If an e-mail address is available for the visitor, then it is captured. The tracker computer processes the information and sets a cookie on the visitor's HTML rendering component.

Decision 230: If the visitor wishes to view another document that is tracker-enabled, then the process repeats itself.

Step 240: If the visitor does not view another tracker-enabled document, then the monitored session will end. The cookie will remain on the visitor's HTML rendering component for use in any subsequent access. End the process.

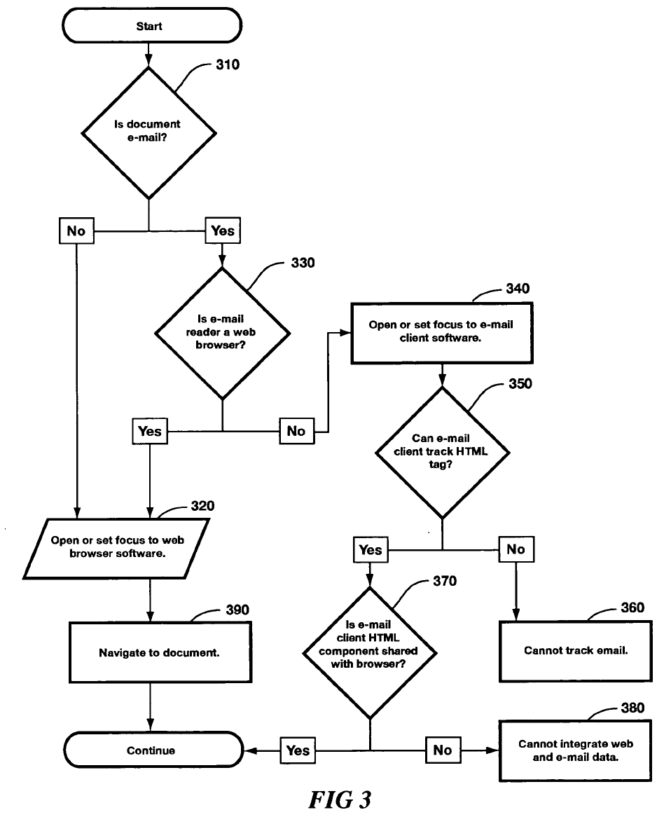

FIG. 3 shows details for FIG. 2, Step 210.

Decision 310: Determine if the document we are viewing is an e-mail or some other type of tracker-enabled document.

Step 320: The visitor opens or sets the focus to a web browser.

Decision 330: If the tracker-enabled document is an e-mail, then determine if the visitor will use a web browser to read the e-mail or use another e-mail software tool.

Step 340: The visitor opens or sets the focus to the e-mail software that will be used to read the e-mail.

Decision 350: Determine if the e-mail software can use the tracking tag and render an HTML document.

Step 360: Do not track e-mail sent to a visitor that does not have e-mail software that can render HTML. End the process.

Decision 370: Determine if the e-mail software shares its HTML rendering component with the primary web browser that the visitor uses. If the rendering component is the same, then cookies can be shared across applications.

Step 380: Do not integrate e-mail and web data if cookies cannot be shared between the e-mail program and the visitor's primary web browser.

Step 390: Navigate to the tracker-enabled document.

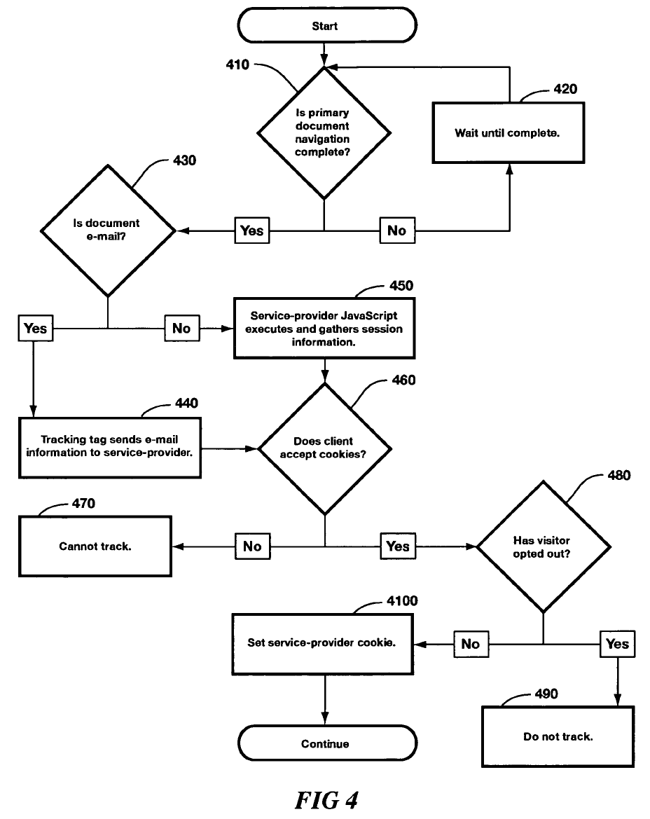

FIG. 4 show details for FIG. 2, Step 220:

Decision 410: Determine if the primary request for the document has been completed. The primary request will download and detect any service-provider software.

Step 420: The primary document request has not been completed, so the service-provider software has not been detected yet. Wait for the primary request to be completed.

Decision 430: Determine if the tracker-enabled document is an e-mail.

Step 440: An HTML tag will be embedded in the e-mail. A parameter of the HTML tag will reference a URL on a tracker computer server and will have the visitor's e-mail address embedded in the request string of the URL.

Step 450: Service-provider software (JavaScript or HTML) will execute in the visitor's browser, gathering and updating information about the visitor's session.

Decision 460: Determine if the visitor's browser is set to accept cookies.

Step 470: If the visitor's browser cannot accept cookies, then do not track them.

Decision 480: Determine if the visitor has opted out of service-provider tracking. This is done through a separate process on a special web page on the service-provider site before this process begins.

Step 490: If the visitor has opted out of tracking, then the service provider will not track them and hence will not correlate e-mail address to session.

Step 4100: Set the service-provider cookie on the HTML rendering component on the visitor's web browser.

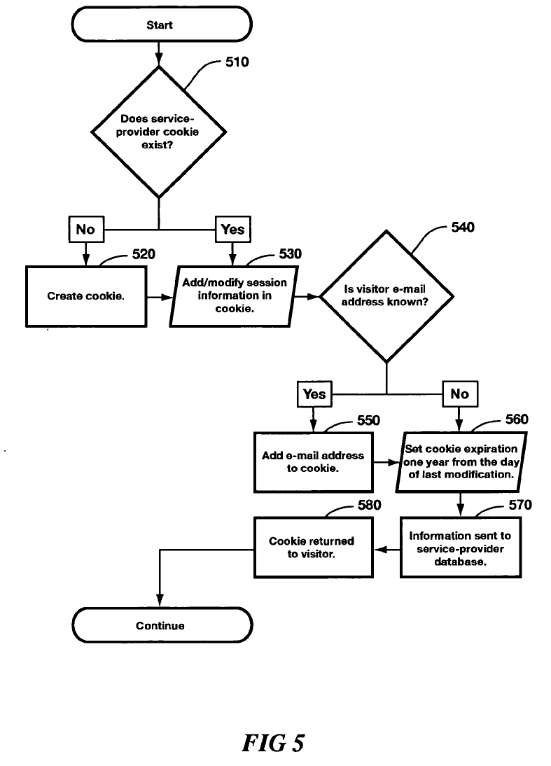

FIG. 5 illustrates details for FIG. 4, Step 4100:

Decision 510: Determine if a service-provider cookie already exists on the visitor's browser.

Step 520: If a service-provider cookie does not already exist, then create a new one. The cookie will contain a unique identifier for the visitor.

Step 530: Take session information that was sent to service-provider servers and process it. The information is analyzed and either added or used to update existing information in the cookie.

Decision 540: Determine if the visitor's e-mail address was sent to the service-provider server with the other session information.

Step 550: Decrypt the e-mail address if necessary, and add it to the service-provider cookie.

Step 560: If desired, set the cookie expiration to a specified length of time.

Step 570: Send the visitor's session information to the service-provider database.

Step 580: Send the service-provider cookie back to the visitor.

In all, present innovation provides a method of tracking, correlating, and analyzing a visitor's e-mail and website access and behavior, that is more automatic, less expensive, and more accurate than previous techniques provided. Moreover, it is fast enough to be done in real time and provides a unique identifier that does not change with a visitor's multiple Internet sessions. Furthermore, it employs a simple system requiring a minimum of software and hardware tools. It is also versatile enough to capture a wide range of a visitor's e-mail and website access and behavior.

The description of the instant invention given above is only one embodiment for implementing the invention. As will be apparent to those skilled in the art, different embodiments of the instant invention may employ a wide range of possible hardware and of software techniques. For example the communication between websites and visitors could take place through any number of links including wired, wireless, infrared, or radio ones and through other communication networks beside the Internet. Also, the term computer as used here is used in its broadest sense to include personal computers, laptops, and servers and it should be recognized that it could include multiple servers, with storage and software functions divided among the servers. A wide array of operating systems and compatible e-mail services and web browsers can be used to collect and correlate the required information, and the communications and data-collection software can be written with many different tools. Moreover the website behavior that is tracked and analyzed can comprise more types than those specifically mentioned here. In addition, the present innovation can comprise log-file analysis as well, through configuring a server to identify cookies with captured e-mail addresses.

1. A method of tracking, correlating, and analyzing the e-mail and internet activities of an Internet visitor, comprising:
adding a tag to a document to create a tracker-enabled document;
providing said tracker-enabled document to said visitor on world wide web; and
capturing an e-mail address from said visitor.

2. The method of claim 1 wherein said tracker-enabled document is an HTML rendered e-mail comprising;
an embedded HTML tag with e-mail address of said visitor;
and said capturing of an e-mail address comprises:
when said e-mail is opened or the focus of a browser e-mail is set;
storing said visitor's e-mail address in a cookie;
adding a unique identifier to said cookie; and
embedding said cookie in visitor's HTML rendering component.

3. The method of claim 1 wherein said tracker-enabled document contains an on-line form for said visitor to enter an e-mail address in a required field and said capturing of an e-mail address comprises:
when e-mail address is entered;
storing said e-mail address in a cookie;
adding a unique identifier to said cookie; and
embedding said cookie in visitor's HTML rendering component.

4. The method of claim 1 wherein said tracker-enabled document contains an on-line form for visitor to enter a visitor name and a password and said capturing of an e-mail address comprises:
when visitor name is entered;
capturing a previously stored e-mail address for that visitor name;
storing said previously stored e-mail address in a cookie;
adding a unique identifier to said cookie; and
embedding said cookie in visitor's HTML rendering component.

5. The method of claim 1 wherein said tracker-enabled document is a web page and comprises:
an embedded JavaScript or HTML tag that references a URL on a service provider server and enables document to gather visitor information about document's usage and initiates a session that service provider monitors.

6. The method of claim 5 further comprising;
storing obtained visitor information in a database on a service provider server.

7. The method of claim 5 further comprising;
adding said information about documents usage into service provider cookie for return to visitor browser.

8. The method of claim 5 wherein a web site owner accesses an account on a service provider server and obtains a report on visitor's activities.

9. A software program product for use in a computer system that executes program steps to track, correlate, and analyze the e-mail and internet activities of an internet visitor, comprising:
a program of computer readable instructions executable by said computer system to perform the method steps comprising;
adding a tag to a document to create a tracker-enabled document;
providing said tracker-enabled document to said visitor on world wide web; and
capturing an e-mail address from said visitor.

10. The software program product of claim 9 wherein said tracker enabled document is an HTML rendered e-mail comprising;
an embedded HTML tag with e-mail address of said visitor;
and said capturing of an e-mail address comprises:
when said e-mail is opened or the focus of a browser e-mail is set;
storing said visitor's e-mail address in a cookie;
adding a unique identifier to said cookie; and
embedding said cookie in visitor's HTML rendering component.

11. The software program product of claim 9 wherein said tracker-enabled document contains an on-line form for said visitor to enter an e-mail address in a required field and said capturing of an e-mail address comprises:
when e-mail address is entered;
storing said e-mail address in a cookie;
adding a unique identifier to said cookie; and
embedding said cookie in visitor's HTML rendering component.

12. The software program product of claim 9 wherein said tracker-enabled document contains an on-line form for visitor to enter a visitor name and a password and said capturing of an e-mail address comprises:
when visitor name is entered;
capturing a previously stored e-mail address for that visitor name;
storing said previously stored e-mail address in a cookie;
adding a unique identifier to said cookie; and
embedding said cookie in visitor's HTML rendering component.

13. The software program product of claim 9 wherein said tracker-enabled document is a web page and comprises:
an embedded JavaScript or HTML tag that references a URL on a service provider server;
an e-mail address of said visitor; and
embedded service provider software that enables document to gather visitor information about document's usage and initiates a session that service provider monitors.

14. The software program product of claim 9 wherein said program of computer readable instructions executable by the computer system to perform the method steps further comprise;
storing obtained visitor information in a database on a service provider server.
adding said information about documents usage into service provider cookie for return to visitor browser.

15. The software program product of claim 9 wherein said program of computer readable instructions executable by the computer system to perform the method steps further comprise;
providing a report on said visitor's activities when requested by a web site owner.
